(19) United States
(12) Patent Application Publication
(10) Pub. No.: US 2010/0157051 A1
(43) Pub. Date: Jun. 24, 2010

(54) SYSTEM AND METHOD FOR DETECTING AND DETERRING RFID TAG RELATED FRAUD

(75) Inventor: Sharathchandra U. Pankanti, Darien, CT (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/342,482

(22) Filed: Dec. 23, 2008

(51) Int. Cl. H04N 9/47

(52) U.S. Cl. 348/143; 382/165; 348/E11.001

(57) ABSTRACT

An approach that allows for detecting and deterring RFID tag related fraud is provided. In one embodiment, there is a generating tool configured to generate a set of tag-item models based on results of a cumulative training process; detecting tool configured to detect discrepancy between an expected appearance of the item as determined from analyzing corresponding tag-item model and an actual appearance of the item as captured by color camera, and an acknowledging tool configured to acknowledge said detected discrepancy.

### FIELD OF THE INVENTION

The present invention generally relates to surveillance systems. Specifically, the present invention provides a method for deterring RFID related fraud.

### BACKGROUND OF THE INVENTION

Surveillance systems today provide a whole new level of pro-active control and monitoring. Network video technology not only offers superior loss prevention, but it can also be used to boost sales, improve staff and customer security, optimize store layouts, boost productivity, monitor flow control, and to improve many more key functions. Many such surveillance systems also allow for obtaining valuable asset tracking information therefore allowing for improved asset management.

For instance, radio-frequency identification (RFID) technology enables the automated gathering and sending of asset information including equipment location, meter readings, maintenance status, and much more—without a person needing direct line of sight or contact with that asset. Once the RFID reader gathers data, the information is passed to the organization's EAM/CMMS application. As a result, the system may trigger an alert, release a work order, update inventory, conduct inspections, create an invoice, locate an asset, etc.

Unfortunately, with increased volumes of shoppers and in-store employees, theft is growing at an alarming rate. In an attempt to detect such theft, many variations of in-store surveillance systems are implemented. Data gathered by such systems is often analyzed and, based on such analysis, further actions are determined. Recently, RFID tag based systems were introduced for deterring shopper and employee related theft. However, as of today there are many difficulties associated with administration of such RFID tags. For instance, employees that are entrusted with RFID administration can easily attach incorrect RFID tags thereby confusing the asset management system and creating potential for easily defrauding store owners.

Thus, there exist a need for providing a method and a system for detecting and deterring RFID tag related fraud using camera-based appearance check of said RFID tag, the method comprising: generating a set of tag-item models during a cumulative training process; detecting discrepancy between appearance of an item and appearance of the tag-item model for said item, and acknowledging said detected discrepancy.

### SUMMARY OF THE INVENTION

In one embodiment there is a method for detecting and deterring RFID tag related fraud using a color camera based appearance check, the method comprising: generating a set of tag-item models during a cumulative training process; detecting discrepancy between an expected appearance of the item as determined from analyzing corresponding tag-item model and an actual appearance of the item as captured by color camera, and acknowledging the detected discrepancy.

In a second embodiment, there is a system for detecting and deterring RFID tag related fraud using a color camera based appearance check, the system comprising: at least one processing unit; memory operably associated with the at least one processing unit; a generating tool storable in memory and executable by the at least one processing unit, such generating tool configured to generate a set of tag-item models based on results of a cumulative training process; a detecting tool storable in memory and executable by the at least one processing unit, such detecting tool configured to detect discrepancies between an expected appearance of the item as determined from analyzing corresponding tag-item model and an actual appearance of the item as captured by color camera, and an acknowledging tool storable in memory and executable by the at least one processing unit, such acknowledging tool configured to acknowledge the detected discrepancies.

In a third embodiment, there is a computer-readable medium storing computer instructions, which when executed, enables a computer system to detect and deter RFID tag related fraud using a color camera based appearance check, the computer instructions comprising: generating a set of tag-item models during a cumulative training process; detecting discrepancy between an expected appearance of the item as determined from analyzing corresponding tag-item model and an actual appearance of the item as captured by color camera, and acknowledging the detected discrepancy.

In a fourth embodiment, there is a method for deploying a deterring tool for deterring RFID tag related fraud using a color camera based appearance check, such method comprising: providing a computer infrastructure operable to: generate a set of tag-item models during a cumulative training process; detect discrepancy between an expected appearance of the item as determined from analyzing corresponding tag-item model and an actual appearance of the item as captured by color camera, and acknowledge the detected discrepancy.

### BRIEF DESCRIPTION OF THE DRAWINGS

FIG. 1 shows a schematic of an exemplary computing environment in which elements of the present invention may operate;

FIG. 2 depicts a process of generating a set of tag-item models during training process;

FIG. 3 illustrates the process of comparing visual features;

FIG. 4 depicts the process of determining differences in the visual features;

FIG. 5 illustrates sample checkout item data; and

FIG. 6 depicts the flow chart of the detecting and deterring process.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to a method and a system for detecting and deterring RFID tag related fraud using a color camera based appearance check.

In one embodiment there is a method for detecting and deterring RFID tag related fraud using a color camera based appearance check, the method comprising: generating a set of tag-item models during a cumulative training process; detecting discrepancy between an expected appearance of the item as determined from analyzing corresponding tag-item model and an actual appearance of the item as captured by color camera, and acknowledging the detected discrepancy.

In a second embodiment, there is a system for detecting and deterring RFID tag related fraud using a color camera based appearance check, the system comprising: at least one processing unit; memory operably associated with the at least one processing unit; a generating tool storable in memory and executable by the at least one processing unit, such generating tool configured to generate a set of tag-item models based on results of a cumulative training process; a detecting tool storable in memory and executable by the at least one processing unit, such detecting tool configured to detect discrepancies between an expected appearance of the item as determined from analyzing corresponding tag-item model and an actual appearance of the item as captured by color camera, and an acknowledging tool storable in memory and executable by the at least one processing unit, such acknowledging tool configured to acknowledge the detected discrepancies.

In a third embodiment, there is a computer-readable medium storing computer instructions, which when executed, enables a computer system to detect and deter RFID tag related fraud using a color camera based appearance check, the computer instructions comprising: generating a set of tag-item models during a cumulative training process; detecting discrepancy between an expected appearance of the item as determined from analyzing corresponding tag-item model and an actual appearance of the item as captured by color camera, and acknowledging the detected discrepancy.

In a fourth embodiment, there is a method for deploying a deterring tool for deterring RFID tag related fraud using a color camera based appearance check, such method comprising: providing a computer infrastructure operable to: generate a set of tag-item models during a cumulative training process; detect discrepancy between an expected appearance of the item as determined from analyzing corresponding tag-item model and an actual appearance of the item as captured by color camera, and acknowledge the detected discrepancy.

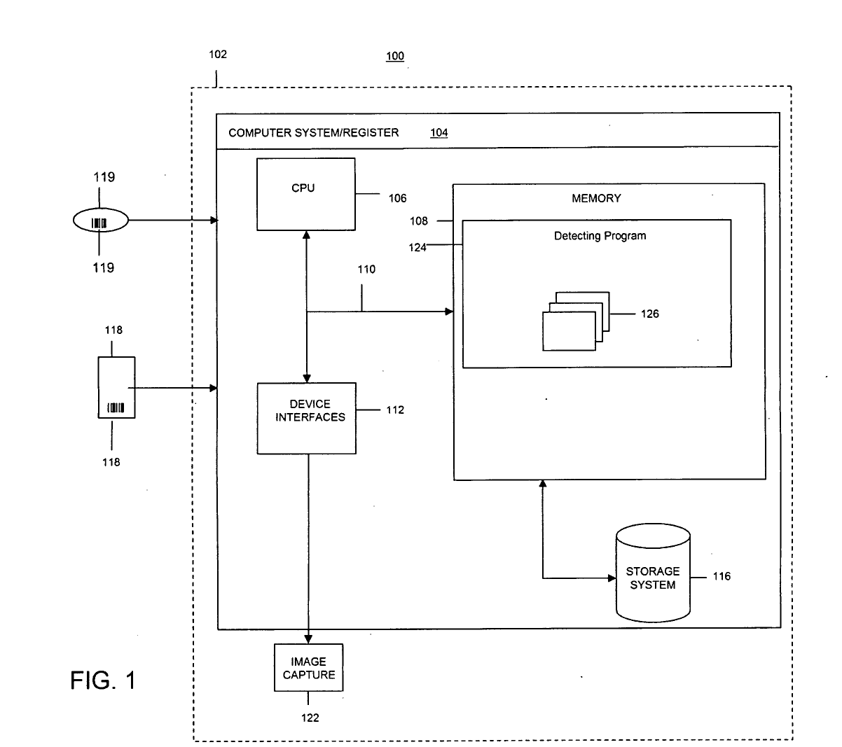

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for detecting and deterring RFID tag related fraud using a color camera based appearance check. It should be understood that any other computers implemented under the present invention may have different components/software, but will perform similar functions. As shown, computer system 104 includes a processing unit 106 capable of analyzing video surveillance, and producing a usable output, e.g., compressed video and video meta-data. Also shown is memory 108 for storing a deterring program 124, a bus 110, and device interfaces 112.

Computer system 104 is shown communicating with one or more image capture devices 122 that communicate with bus 110 via device interfaces 112.

Processing unit 106 collects and routes signals representing outputs from image capture devices 122 to deterring program 124. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the video signals may be encrypted using, for example, trusted key-pair encryption. Different capture devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)). In some embodiments, image capture devices 122 are capable of two-way communication, and thus can receive signals (to power up, to sound an alert, etc.) from deterring program 124.

In general, processing unit 106 executes computer program code, such as program code for executing deterring program 124, which is stored in memory 108 and/or storage system 116. While executing computer program code, processing unit 106 can read and/or write data to/from memory 108 and storage system 116. Storage system 116 stores video metadata generated by processing unit 106, as well as rules and attributes against which the metadata is compared to identify objects and attributes of objects present within scan area (not shown). Storage system 116 can include VCRs, DVRs, RAID arrays, USB hard drives, optical disk recorders, flash storage devices, image analysis devices, general purpose computers, video enhancement devices, de-interlacers, scalers, and/or other video or data processing and storage elements for storing and/or processing video. The video signals can be captured and stored in various analog and/or digital formats, including, but not limited to, Nation Television System Committee (NTSC), Phase Alternating Line (PAL), and Sequential Color with Memory (SECAM), uncompressed digital signals using DVI or HDMI connections, and/or compressed digital signals based on a common codec format (e.g., MPEG, MPEG2, MPEG4, or H.264).

Although not shown, computer system 104 could also include I/O interfaces that communicate with one or more external devices 118 that enable a user to interact with computer system 104 (e.g., a keyboard, a pointing device, a display, etc.).

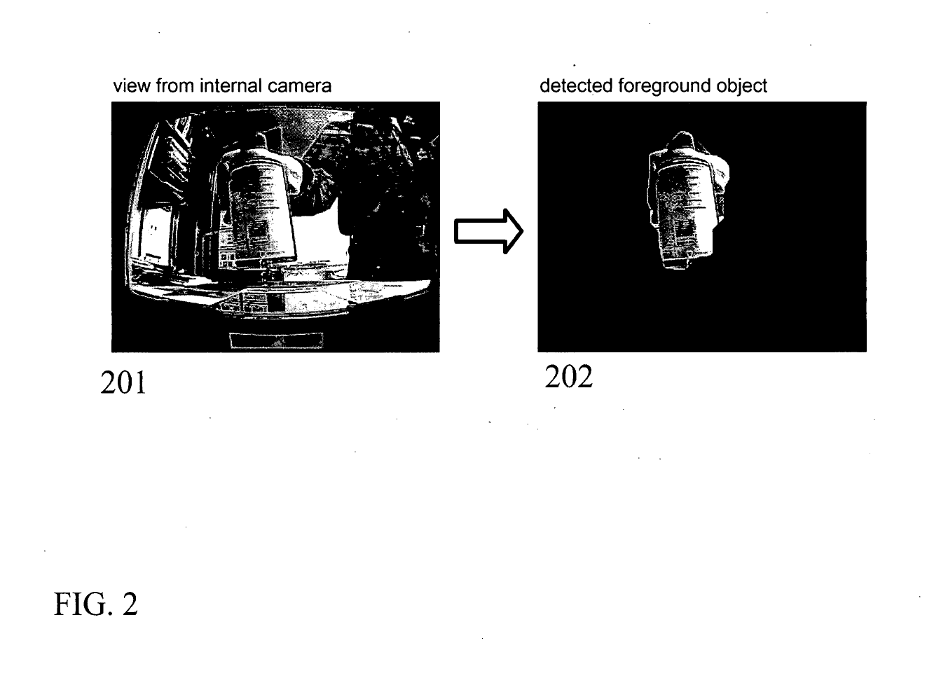

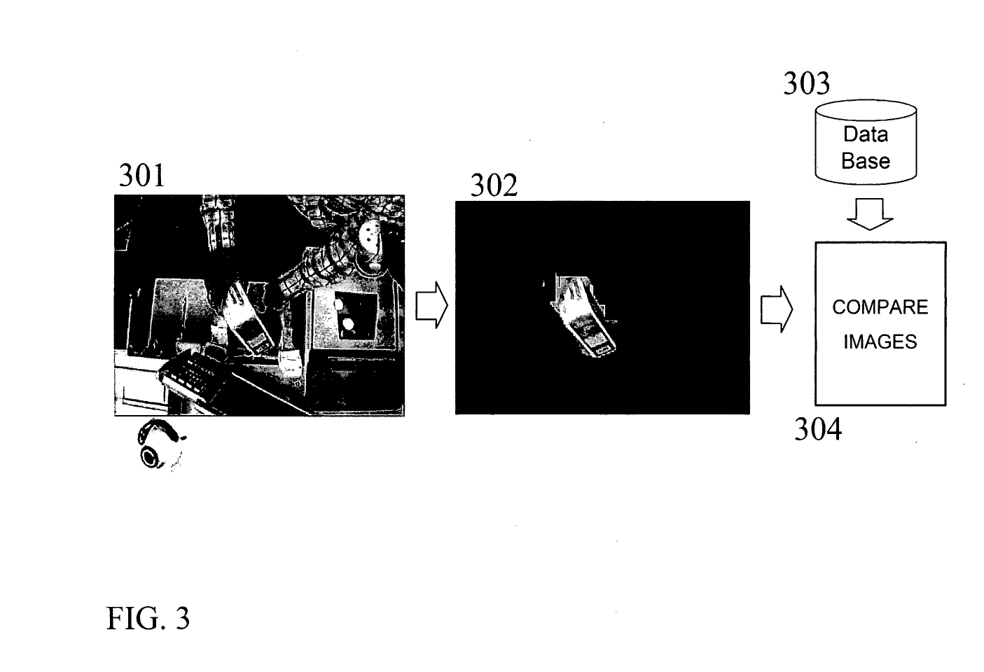

FIG. 2 depicts a process of generating a set of tag item models. As illustrated, RFID tag 201 is recorded. Thereafter, visual features of the object 202 associated with the recorded RFID tag are extracted. The association of the recorded RFID tag 201 and the extracted visual features of the object 202 associated with said recorded RFID tag is thereafter stored as a tag-item model in database 303 (FIG. 3).

FIG. 3 illustrates the process of comparing visual features of the expected appearance of the item and the actual appearance of the item. As illustrated, at 301 an overhead color camera captures the image of the actual item. The scanner at the same time establishes the RFID tag as it is scanned by the checker. At 302 the image of the actual appearance of the item is isolated from the rest of the images caught by the overhead camera view. Based on the scanned RFID tag parameter expected appearance of the item is obtained from database 303. At step 304 the visual features of the expected appearance of the item and the actual appearance of the item are compared.

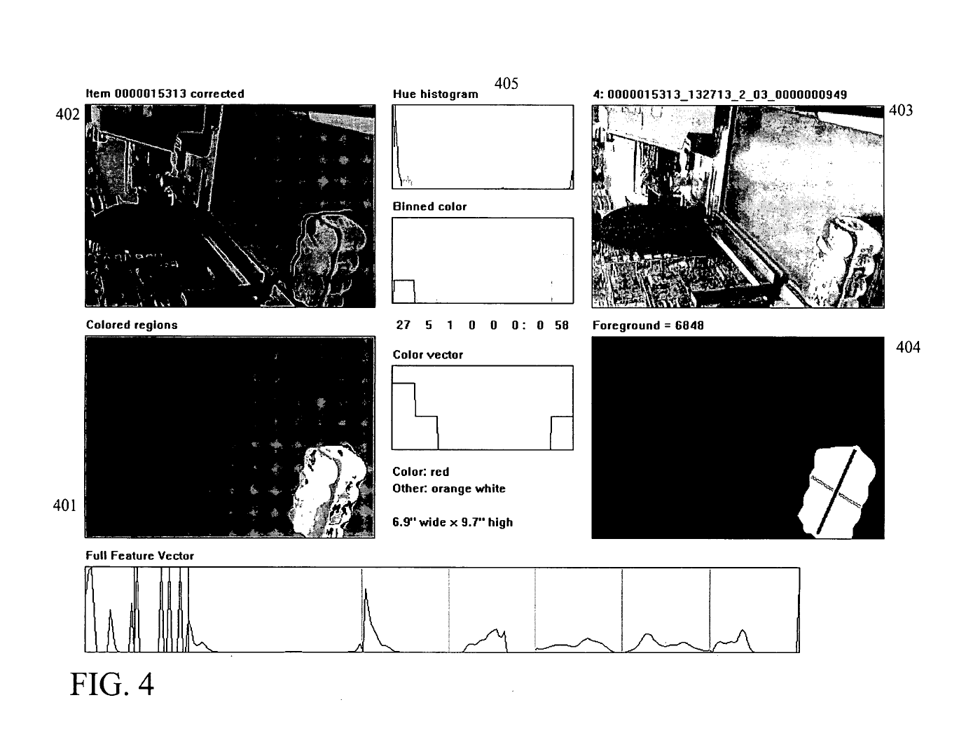

FIG. 4 depicts the process of determining specific differences in the visual features of the appearances of the items. As shown, at 401 and 404 general parameters are first compared. Further, at 402 and 403 more detailed comparison is provided, i.e. directions of the items are analyzed (not shown) and colors are compared through hue histogram 405.

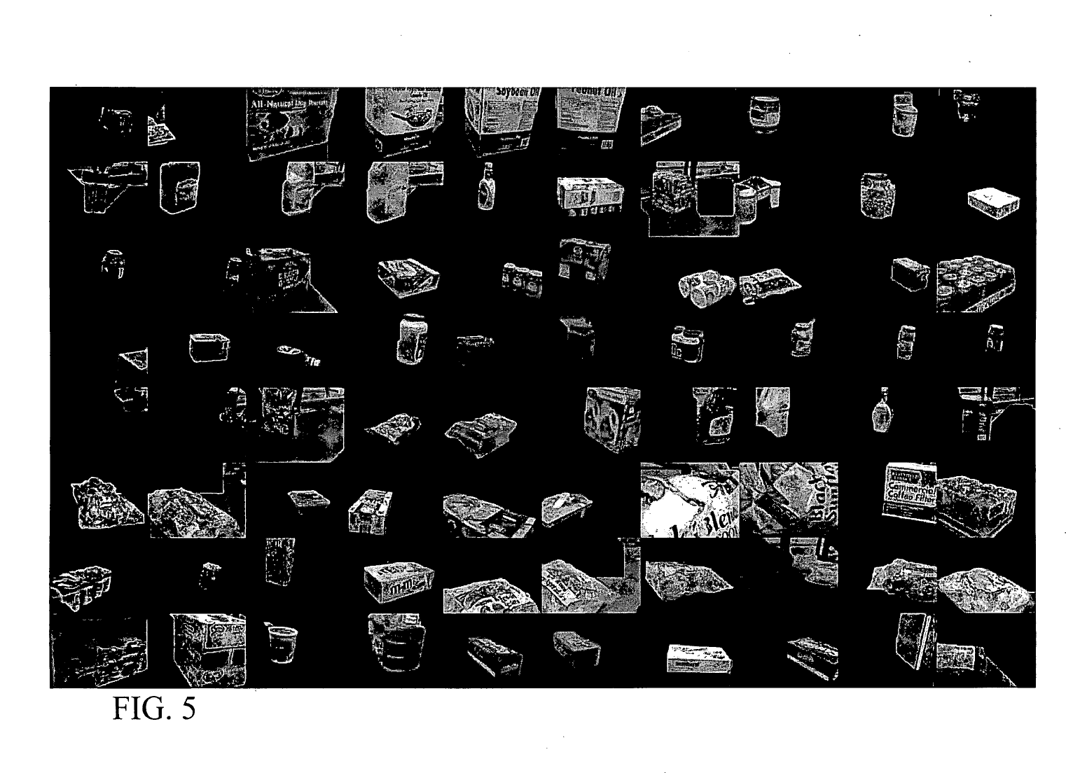

FIG. 5 illustrates sample checkout item data. As can be seen from FIG. 5 there is a potential for segmented objected appearance, which is therefore provisioned for (not shown) during the training process.

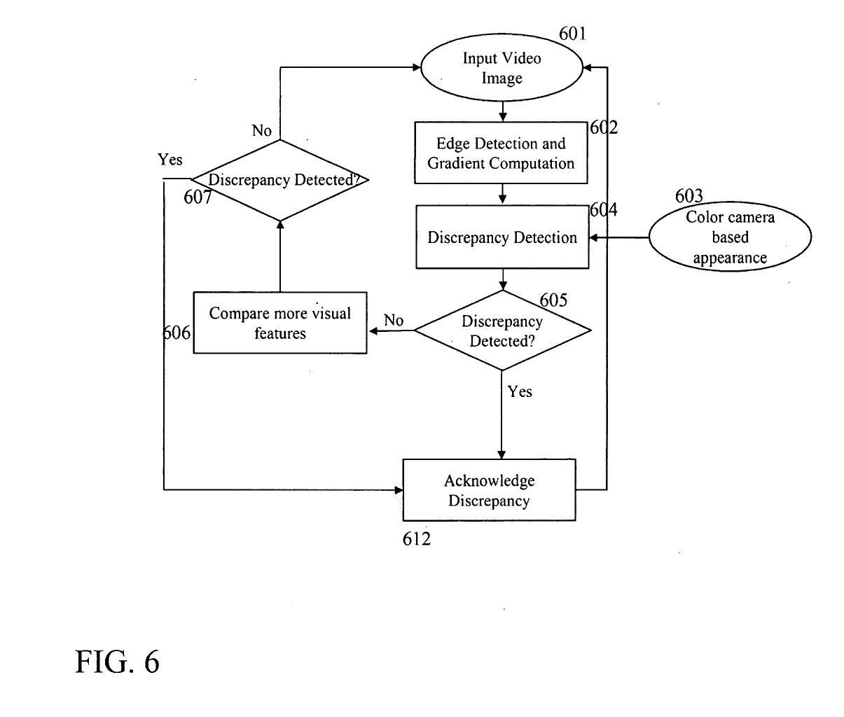

FIG. 6 depicts the flow chart of the detecting and deterring process. As shown, at step 601 new input video image is received. At step 602 edge detection and gradient computation are performed to extract visual features of the object obtained by the video image. At step 604 discrepancy detection is performed by comparing visual features of expected appearance of the item received and the actual appearance of the item. If at 605 it is established that discrepancy is detected, then at 612 the discrepancy is acknowledged by sounding of an alarm, logging of operator identification, logging the picture of the item and logging corresponding RFID tag. However, if at 605 discrepancy is not detected, at 606 detection takes place further by more detailed comparison of the visual features of the items. Thereafter, again if the discrepancy is detected at 607 then 612 the discrepancy is acknowledged by sounding of an alarm, logging of operator identification, logging the picture of the item and logging corresponding RFID tag.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and server. A module may be a component of a device, software, program, or system that implements some “functionality”, which can be embodied as software, hardware, firmware, electronic circuitry, or etc.

What is claimed is:

1. A method for detecting and deterring RFID tag related fraud using a color camera based appearance check, said method comprising:
generating a set of tag-item models during a cumulative training process;
detecting discrepancy between an expected appearance of the item as determined from analyzing corresponding tag-item model and an actual appearance of the item as captured by color camera, and
acknowledging said detected discrepancy.

2. The method according to claim 1, said generating a set of tag-item models further comprising:
recording RFID tag,
extracting visual features of an object associated with said recorded RFID tag, and
storing said recorded RFID tag and said extracted visual features of said object associated with said recorded RFID tag as a tag-item model.

3. The method according to claim 1, said detecting discrepancy between said expected appearance of the item and said actual appearance of the item further comprising:
comparing visual features of said expected appearance of the item and said actual appearance of the item, and
determining differences in said visual features between said expected appearance of the item and said actual appearance of the item.

4. The method according to claim 1, said acknowledging said detected discrepancy comprising:
triggering of an alarm,
logging an identification number for the current check out operator;
logging said visual features of the item, and
logging said corresponding RFID tag.

5. A system for detecting and deterring RFID tag related fraud using a color camera based appearance check, said system comprising:
at least one processing unit;
memory operably associated with the at least one processing unit;
a generating tool storable in memory and executable by the at least one processing unit, said generating tool configured to generate a set of tag-item models based on results of a cumulative training process;
a detecting tool storable in memory and executable by the at least one processing unit, said detecting tool configured to detect discrepancy between an expected appearance of the item as determined from analyzing corresponding tag-item model and an actual appearance of the item as captured by color camera, and
an acknowledging tool storable in memory and executable by the at least one processing unit, said acknowledging tool configured to acknowledge said detected discrepancy.

6. The generating tool according to claim 5 further comprising:
a recording component configured to record RFID tag,
an extracting component configured to extract visual features of an object associated with said recorded RFID tag, and
a storing component configured to store said recorded RFID tag and said extracted visual features of said object associated with said recorded RFID tag as a tag-item model.

7. The detecting tool according to claim 5 further comprising:
a comparing component configured to compare visual features of said expected appearance of the item and said actual appearance of the item, and
a determining component configured to determine differences in said visual features between said expected appearance of the item and said actual appearance of the item

8. The acknowledging tool according to claim 5, further comprising:
a triggering component configured to trigger an alarm;
a logging component configured to log an identification number for the current check out operator;
a logging component configured to log said visual features of the item, and
a logging component configured to log said corresponding RFID tag.

9. A computer-readable medium storing computer instructions, which when executed, enable a computer system to detect and deter RFID tag related fraud using a color camera based appearance check, the computer instructions comprising:
generating a set of tag-item models during a cumulative training process;
detecting discrepancy between an expected appearance of the item as determined from analyzing corresponding tag-item model and an actual appearance of the item as captured by color camera, and
acknowledging said detected discrepancy.

10. The computer-readable medium according to claim 9 further comprising computer instructions for:
recording RFID tag,
extracting visual features of an object associated with said recorded RFID tag, and
storing said recorded RFID tag and said extracted visual features of said object associated with said recorded RFID tag as a tag-item model.

11. The computer-readable medium according to claim 9 further comprising computer instructions for:
comparing visual features of said expected appearance of the item and said actual appearance of the item, and
determining differences in said visual features between said expected appearance of the item and said actual appearance of the item.

12. The computer-readable medium according to claim 9 further comprising computer instructions for:
triggering of an alarm,
logging an identification number for the current check out operator;
logging said visual features of the item, and
logging said corresponding RFID tag.

13. A method for deploying a deterring tool for deterring RFID tag related fraud using a color camera based appearance check, said method comprising:
providing a computer infrastructure operable to:
generate a set of tag-item models during a cumulative training process;
detect discrepancy between an expected appearance of the item as determined from analyzing corresponding tag-item model and an actual appearance of the item as captured by color camera, and
acknowledge said detected discrepancy.

14. The method according to claim 13, the computer infrastructure further operable to:
record RFID tag,
extract visual features of an object associated with said recorded RFID tag, and
store said recorded RFID tag and said extracted visual features of said object associated with said recorded RFID tag as a tag-item model.

15. The method according to claim 13, the computer infrastructure further operable to:
compare visual features of said expected appearance of the item and said actual appearance of the item, and
determine differences in said visual features between said expected appearance of the item and said actual appearance of the item.

16. The method according to claim 13, the computer infrastructure further operable to:
trigger an alarm,
log an identification number for the current check out operator;
log said visual features of the item, and
log said corresponding RFID tag.
